(19) United States
(12) Patent Application Publication
(10) Pub. No.: US 2026/0078727 A1
(43) Pub. Date: Mar. 19, 2026

(54) AIR INTAKE SYSTEMS FOR POWER MACHINES

(71) Applicant: Doosan Bobcat North America, Inc., West Fargo, ND (US)

(72) Inventors: Ryan Eberhardt, Bismarck, ND (US); Talon Mack, New Salem, ND (US)

(21) Appl. No.: 19/331,611

(22) Filed: Sep. 17, 2025

Related U.S. Application Data
(60) Provisional application No. 63/695,740, filed on Sep. 17, 2024.

(51) Int. Cl. F02M 35/08; B01D 46/00; B01D 46/48; B01F 23/10; B01F 23/70; B01F 25/312; F02M 35/02

(52) U.S. Cl. CPC F02M 35/086; B01D 46/0047; B01D 46/48; B01F 23/10; B01F 23/708; B01F 25/31243; B01F 25/312521; B01F 25/312531; B01F 25/312533; F02M 35/0202; B01D 2279/60

(57) ABSTRACT

A power machine can include a frame, an engine supported by the frame, and an air intake system that directs intake air to the engine. The air intake system can include a filter assembly that includes a filter housing and a filter element positioned in the filter housing to filter contaminants from the intake air. A pressure source can be arranged to pressurize filtered air from the filter assembly and provide the pressurized filtered air to an intake of the engine. The air intake system can further include an ejector arranged to receive a portion of the pressurized filtered air and induce a suction flow at the filter housing to eject contaminants from the air intake system.

### CROSS-REFERENCE TO RELATED APPLICATIONS

This application claims the benefit of U.S. provisional application No. 63/695,740, filed 17 Sep. 2024, which is hereby incorporated by reference in its entirety as though fully set forth herein.

### BACKGROUND

This disclosure is directed toward power machines. More particularly, this disclosure is directed to air filtration systems for power machines (e.g., for an internal combustion engine of a power machine). Power machines, for the purposes of this disclosure, include any type of machine that generates power to accomplish a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include loaders (including mini-loaders), excavators, utility vehicles, mowers, tractors (including compact tractors), and trenchers, to name a few examples.

Power machines that include internal combustion engines include air intake systems. Air intake systems usually directs air flow to a filter element to filter the air entering the engine. Contaminants, including debris, dust, pollutants, or other particles can thus be removed from the air.

The discussion above is merely provided for general background information and is not intended to be used as an aid in determining the scope of the claimed subject matter.

### SUMMARY

The present disclosure provides improved air intake systems for power machines, including through a use of aspiration systems to remove debris from filtered air from air filter housing on the power machines. In some examples, a power machine can include a frame, an engine supported by the frame, and an air intake system that directs intake air to the engine. The air intake system can include a filter assembly that includes a filter housing and a filter element positioned in the filter housing to filter contaminants from the intake air. A pressure source can be arranged to pressurize filtered air from the filter assembly and provide the pressurized filtered air to an intake of the engine. The air intake system can further include an ejector arranged to receive a portion of the pressurized filtered air and induce a suction flow at the filter housing to eject contaminants from the air intake system.

According to some embodiments, an air intake system for an engine of a power machine is provided. The air intake system can include a filter housing, a filter element arranged in an airflow between an inlet and an outlet of the filter housing to filter contaminants from intake air for the engine, and an ejector including a suction inlet port, a motive inlet port, a Venturi passage in fluid communication with the suction and motive inlet ports, and an outlet body in fluid communication with the Venturi passage. The motive inlet port can be configured receive a motive flow into the Venturi passage to induce a suction flow at the suction inlet port. The suction inlet port can be in fluid communication with the filter housing to receive the filtered contaminants from the filter housing into the Venturi passage via the suction flow. The outlet body can be in fluid communication with the Venturi passage to eject the filtered contaminants from the air intake system.

According to some embodiments, a method of operating an air intake system of a power machine is provided. The power machine can be operated to draw intake air into a filter housing of the air intake system to filter contaminants from the intake air. With an ejector, a vacuum flow can be induced to suction the contaminants from the filter housing. The contaminants can be discharged from the air intake system via the ejector.

This Summary and the Abstract are provided to introduce a selection of concepts in a simplified form that are further described below in the Detailed Description. This Summary is not intended to identify key features or essential features of the claimed subject matter, nor are they intended to be used as an aid in determining the scope of the claimed subject matter.

### DRAWINGS

The following drawings are provided to help illustrate various features of non-limiting examples of the disclosure and are not intended to limit the scope of the disclosure or exclude alternative implementations.

FIG. 1 is a block diagram illustrating functional systems of a representative power machine on which embodiments of the present disclosure can be advantageously practiced.

FIGS. 2-3 illustrate axonometric views of a representative power machine in the form of a skid-steer loader of the type on which the disclosed embodiments can be practiced.

FIG. 4 is a block diagram illustrating components of a power system of a loader such as the loader illustrated in FIGS. 2-3.

FIG. 5 is a block diagram illustrating components of a power machine according to aspects of the disclosed technology.

FIG. 6 illustrates an axonometric partial view of the power machine of FIG. 5 showing details of an air filter and a suction device.

FIG. 7 illustrates an exploded view of the suction device of FIG. 6.

FIG. 8 illustrates a cross-sectional view of the suction device of FIG. 6.

### DETAILED DESCRIPTION

The concepts disclosed in this discussion are described and illustrated by referring to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items. In addition, any feature disclosed with respect to one embodiment may be included in another embodiment, and vice-versa.

Likewise, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

Power machines including loaders often operate in dusty or otherwise dirty environments, and some internal compartments (e.g., engine compartments) are not completely sealed off from the outside environment. For power machines that include an internal combustion engine, intake air for the engine can include dirt, dust, debris, or other particles from the outside environment (herein, generally, “contaminants”), which could impede performance of the engine or otherwise reduce an overall efficiency of the power machine. Conventional power machines can thus include an air intake system that includes a filter element (e.g., cylindrical filters, panel-type filters, etc.). Use of a filter element can provide cleaner air to an engine by filtering out dust or other particles from incoming air. For example, the removed contaminants can remain within the air intake system, and only the filtered air may be directed to an engine for combustion.

During operation of a filter element, dirt or other contaminants can accumulate within a housing of the air intake system over time (e.g., along the interior of a filter housing). In some cases, accumulated dirt can impede airflow into an engine or decrease effectiveness of a filter element. For example, some power machines that require higher horsepower may demand a greater volume of air intake into an engine, and a greater volume of dirt may need to be filtered through an air intake system. However, when a large amount of dirt remains accumulated in a housing, intake airflow can be impeded and consequently lower engine performance. Correspondingly, an air intake system may need to be cleaned periodically to maintain cleanliness of the filter housing (e.g., to extend a lifetime of the filter assembly or decrease frequency of filter replacement). Thus, providing an air intake system that can remain relatively clean and free of contaminants can help to meet the demands of a power engine, particularly in dusty or otherwise high-contaminant environment, as well as generally reduce an overall cost of maintenance.

In some examples, an aspiration system can be provided on an air intake system to remove accumulated dirt from a filter housing. Typical aspiration systems can include a valve (e.g., a squeeze valve or a pinch valve) that is manually engaged to emit dirt from a filter housing. Thus, operators may need to implement regular manual cleaning of the filter, to ensure optimum performance, with associated complexity of overall operations and costs. Further, in some cases, it may be challenging to reach a valve to manually eject contaminants from a filter housing (e.g., because the available location for the valve is below a power machine or otherwise the valve is otherwise enclosed or obstructed). Accordingly, it may be beneficial to provide an improved aspiration system that enhances an overall aspiration process or provides for improved filter maintenance operations.

Some arrangements of the technology disclosed herein can provide improvements for aspiration of an air intake system, including for air intake systems for internal combustion engines. In some examples, an aspiration system can include an ejector that provides a suction flow to eject contaminants from the air filter housing. For example, an ejector can be mounted to or near an air filter housing to apply a suction flow to a port in the air filter housing and provide a corresponding outlet flow to eject the contaminants thus received into the ejector.

In some cases, the ejector can operate as a Venturi device, receiving pressurized flow from a first source to induce a suction flow from an air filter system (e.g., at a port into a lower wall of an air filter housing). For example, boost air for an engine (e.g., drawn from downstream of the relevant filter assembly) can be provided to an ejector to induce a suction airflow from an air filter housing. In some cases, the boost air can be provided by a pressure source powered by the engine (e.g., a turbocharger) and can be drawn, for example, from a charge air cooler or other equipment.

In some cases, relatively low flow of air from a pressure source (e.g., low flow of diverted boost air) can be provided, to avoid excessive drain on engine performance due to restriction of intake flow. Thus, the pressure from the boost air may be relatively low, in some cases, but still sufficient to remove contaminants from the relevant housing. For example, sufficient removal of contaminants can in some cases be optimally achieved with use of less than 5% (e.g., less than 2%, less than 1%, or less than 0.8%) of total air flow.

In some cases, an ejector can include a diffuser that directs contaminants out of the ejector to an exterior of a power machine (e.g., to the ground or other surroundings). In some cases, a length, angle of taper, width, shape (e.g., curvature) or other parameters of a diffuser can be selected in particular to provide improved outcomes for particular applications (e.g., particular engines, operating environments, loading conditions, etc.). In some cases, one or more parts of an ejector can be made with light-weight material, including to facilitate inexpensive mass-production (e.g., using molded or printed polymers). Further, in some examples, an ejector can be modularly constructed, to allow selection of particular modular components to provide particular operational characteristics (e.g., for a particular engine, power machine, etc.). For example, some assemblies or kits can include various modular inlet nozzles, Venturi bodies, and outlet diffusers, with varied flow characteristics or other aspects. These modular components can be interchangeably assembled to selectively provide different flow characteristics, structural envelopes, etc.

Therefore, the presently disclosed technology can provide improved systems and methods for aspirating an air filter, including as further discussed below. In particular, some examples can provide improved manufacturability, flexibility, and operational/maintenance characteristics as compared to conventional aspiration systems.

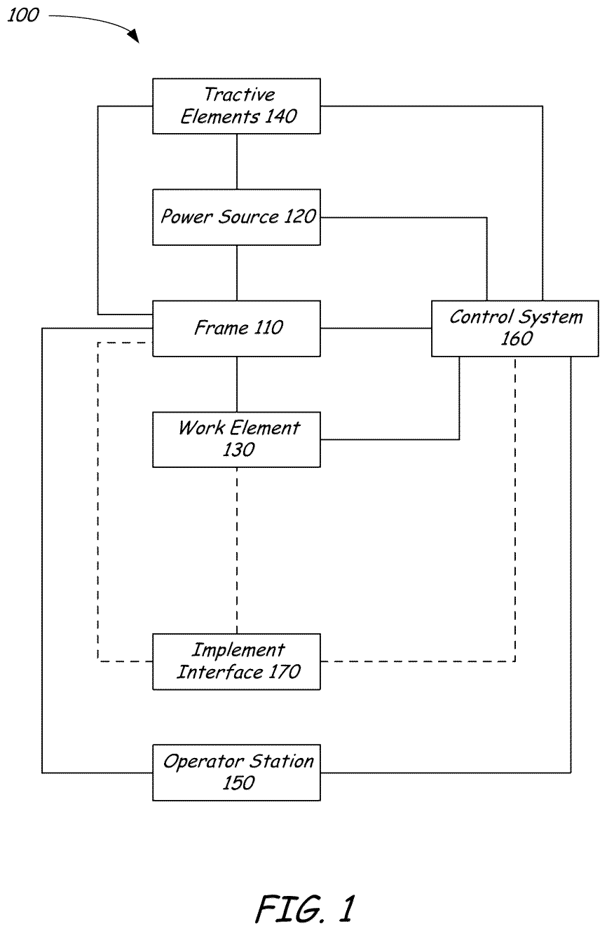

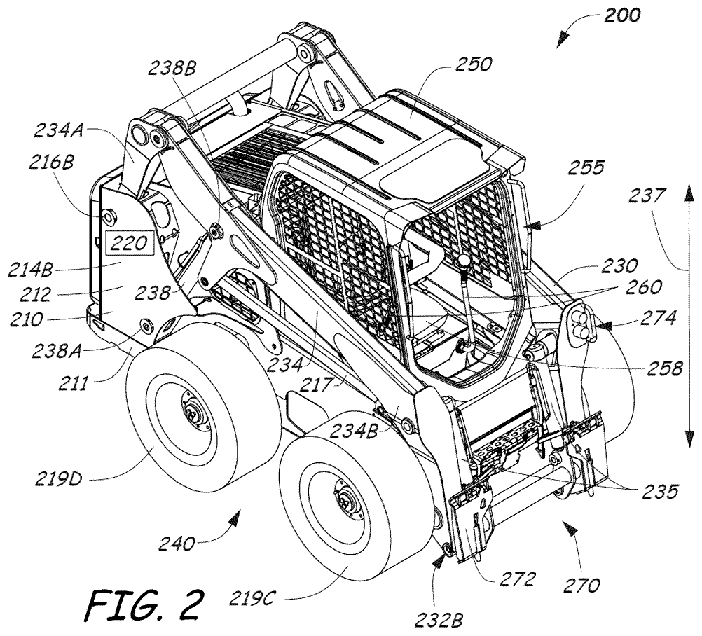

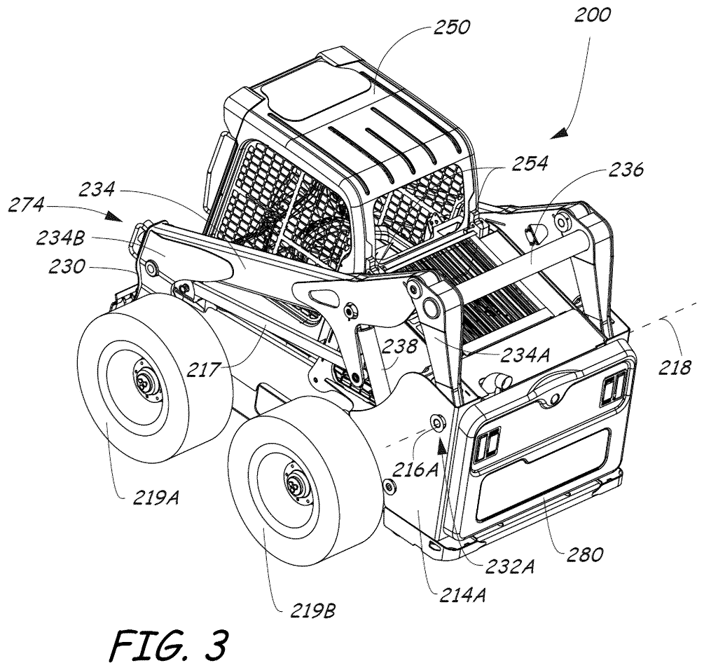

These concepts can be practiced on various power machines, as will be described below. A representative power machine on which the embodiments can be practiced is illustrated in diagram form in FIG. 1 and one example of such a power machine is illustrated in FIGS. 2-3 and described below before any embodiments are disclosed. For the sake of brevity, only one power machine is illustrated and discussed as being a representative power machine. However, as mentioned above, the embodiments below can be practiced on any of a number of power machines, including power machines of different types from the representative power machine shown in FIGS. 2-3. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power.

Although examples herein focus particularly on aspiration systems for air intake systems, implementations of the disclosed technology can be practiced on a variety of power machines with a variety of ground-engaging elements. In this regard, FIG. 1 is a block diagram that illustrates the basic systems of a power machine 100, which can be any of a number of different types of power machines and upon which the embodiments discussed below can be advantageously incorporated. The block diagram of FIG. 1 identifies various systems on power machine 100 and the relationship between various components and systems. In particular, the power machine 100 has a frame 110, a power source 120, a workgroup work element 130 and tractive work elements 140. The workgroup work element 130 can be operated to perform work tasks (e.g., mowing, digging, cutting, grading, etc.) and the tractive work elements 140 can be operated move the power machine over a support surface. In the illustrated example, the power machine 100 also includes an operator station 150 that provides an operating position for controlling the work elements of the power machine. In some examples, however, no operator station may be included.

A control system 160 is provided to interact with other systems of the power machine 100 to perform various tasks, including in response to control signals provided by an operator. For example, the control system 160 can be an integrated or distributed architecture of one or more controllers (e.g., one or more processor devices and one or more memories) that are collectively configured to receive operator input or other input signals (e.g., sensor data) and to output commands accordingly for power machine operations (e.g., workgroup operations, tractive operations, etc.).

Some power machines have work elements that can perform a dedicated task. For example, some power machines include a mower deck that can be attached to a main frame of the work vehicles in various ways (e.g., with a fixed mount, as an implement attached to a lift arm, etc.). Cutting elements of the mower deck can be controlled as needed. For example, the control system 160 can control the speed of one or more rotating blades, or a position of the mower deck relative to the frame, or the mower deck can be otherwise manipulated to perform mowing or other tasks.

Some power machines can include other dedicated work elements, including cutting or drilling implements, buckets, grading blades, and others as variously known in the art. In some cases, work elements can be interchanged on a particular power machine (e.g., as attachable implements that can be supported by a lift arm, or otherwise). In this regard, for example, the power machine 100 as illustrated includes an implement interface 170, which provides a connection between the frame 110 or the work element 130 and an attachable implement. In some cases, the implement interface 170 can be a direct connection to secure an implement directly to the frame 110 or to the work element 130 (e.g., can be a pinned connection directly to a lift arm). In some cases, the implement interface 170 can include a linkage or other support structure, or can be formed as an implement carrier (e.g., which may be configured to secure and support various implements, and may itself be controllably movable relative to the frame 110 or the work element 130). In some examples, the implement interface 170 can be a pinned or other connection that secures a mower deck to a movable support structure, so that the mower deck can be supported at selected heights relative to the frame 110 (and the ground).

In some examples, the frame 110 can be rigid (e.g., formed from a single member, a weldment, or other unified structure). In some examples, at least one portion of the frame 110 may be movable relative to another. For example, excavators can have an upper frame portion that rotates with respect to a lower frame portion, and some power machines can include articulated frames that are pivotable about one or more vertical (or other) axes. Articulated frames, for example, can be used to implement steering operations, provide improved following of terrain, or otherwise.

The frame 110 supports the power source 120, which can provide power to the work element 130 or the tractive elements 140. In some cases, the power source 120 can provide power for use by an implement attached at the implement interface 170. In some examples, power from the power source 120 can be provided directly to the work element 130, the tractive elements 140, or implement interfaces 170 (e.g., via direct mechanical or electrical connection). In some examples, power from the power source can be provided indirectly to the work element 130, the tractive elements 140, or the implement interfaces 170 (e.g., may be transferred via hydraulic operations, or a combination of electrical and hydraulic operations). In some examples, the control system 160 can control routing of power from the power source 120 to other systems (e.g., via a system of electronic, hydraulic, electro-hydraulic, or other control devices, including as generally known in the art).

In some examples, the power source 120 can include an engine (e.g., an internal combustion engine). In some examples, the power source 120 can include an electrical power source (e.g., a battery, a capacitor, a fuel cell, etc.). In some examples, hybrid power sources can be provided (e.g., with a combination of an engine and an electrical power source). In some examples, a power conversion system can be provided to convert power from the power source 120 into other forms useable by the work element 130, the tractive elements 140, or an implement at the implement interface 170. For example, a hydraulic system can be used to convert rotational output from the power source 120 into hydraulic power (e.g., to power hydrostatic or other operations). Similarly, an electrical system can be used to convert electrical output from the power source 120 into non-electrical power (e.g., rotational mechanical power, or hydraulic power via a coupled hydraulic system).

For simplicity of presentation, FIG. 1 shows simple the work element 130, but various examples can include various numbers of work elements. In some examples, as also discussed above, work elements can include mower decks or other similar equipment. In some examples, work elements can include lift arm assemblies or other similar systems. The tractive elements 140 are a special case of work elements and may be provided in various number and configuration. In some examples, tractive elements can be arranged and controllable for independent operation and can be steerable in some cases. In some examples, one or more tractive elements on a first side of the power machine 100 may be separately controllable from one or more tractive elements on a second side of the power machine 100 (e.g., controllable for rotation in opposite directions for “skid steer” operation). Tractive elements can be, for example, wheels attached to an axle, track assemblies, or other assemblies of known configurations to convey tractive power from the frame 110 to a supporting surface.

In some examples, the tractive elements 140 can be rigidly mounted to the frame 110 so as to be limited to rotation about one or more corresponding axles. In some examples, the tractive elements 140 can be pivotally mounted to the frame 110. In some power machines, including zero-radius turn mowers, one or more caster wheels or similar devices can be used in combination with rigidly mounted tractive elements, with the rigidly mounted tractive elements provide tractive power and allowing the power machine to be steered via implementation of different ground-engaging speeds at tractive elements on opposing sides of the power machine. Such an arrangement is referred to herein as a zero-radius turn configuration and can in particular be implemented on mowers, as further discussed below.

In some power machines, the operator station 150 is defined by an enclosed or partially enclosed cab. In some examples, the operation station 150 can include a standing or other platform (e.g., without overhead enclosure). In some examples, the operator station 150 can be a remote station (e.g., as provided by a remote control device not attached to the frame 110). In some examples, the operator station 150 can be supported by the frame 110 by accessible by operators that are not (e.g., by an operator walking behind the power machine 100).

FIGS. 2-3 illustrate a loader 200, which is one particular example of a power machine of the type illustrated in FIG. 1 where the embodiments discussed below can be advantageously employed. Loader 200 is a skid-steer loader, which is a loader that has tractive elements (in this case, four wheels) that are mounted to the frame of the loader via rigid axles. Here the phrase “rigid axles” refers to the fact that the skid-steer loader 200 does not have any tractive elements that can be rotated or steered to help the loader accomplish a turn. Instead, a skid-steer loader has a drive system that independently powers one or more tractive elements on each side of the loader so that by providing differing tractive signals to each side, the machine will tend to skid over a support surface. These varying signals can even include powering tractive element(s) on one side of the loader to move the loader in a forward direction and powering tractive element(s) on another side of the loader to mode the loader in a reverse direction so that the loader will turn about a radius centered within the footprint of the loader itself. The term “skid-steer” has traditionally referred to loaders that have skid steering as described above with wheels as tractive elements. However, it should be noted that many track loaders also accomplish turns via skidding and are technically skid-steer loaders, even though they do not have wheels. For the purposes of this discussion, unless noted otherwise, the term skid-steer should not be seen as limiting the scope of the discussion to those loaders with wheels as tractive elements. Correspondingly, although some example power machines discussed herein are presented as skid-steer power machines, some embodiments disclosed herein can be implemented on a variety of other power machines. For example, some embodiments can be implemented on compact loaders or compact excavators that do not accomplish turns via skid-steer control.

Loader 200 is one particular example of the power machine 100 illustrated broadly in FIG. 1 and discussed above. To that end, features of loader 200 described below include reference numbers that are generally similar to those used in FIG. 1. For example, loader 200 is described as having a frame 210, just as power machine 100 has a frame 110. Skid-steer loader 200 is described herein to provide a reference for understanding one environment on which the embodiments described below related to track assemblies and mounting elements for mounting the track assemblies to a power machine may be practiced. The loader 200 should not be considered limiting especially as to the description of features that loader 200 may have described herein that are not essential to the disclosed embodiments and thus may or may not be included in power machines other than loader 200 upon which the embodiments disclosed below may be advantageously practiced. Unless specifically noted otherwise, embodiments disclosed below can be practiced on a variety of power machines, with the loader 200 being only one of those power machines. For example, some or all of the concepts discussed below can be practiced on many other types of work vehicles such as various other loaders, excavators, trenchers, and dozers, to name but a few examples.

Loader 200 includes frame 210 that supports a power system 220, the power system being capable of generating or otherwise providing power for operating various functions on the power machine. Power system 220 is shown in block diagram form, but is located within the frame 210. Frame 210 also supports a work element in the form of a lift arm assembly 230 that is powered by the power system 220 and that can perform various work tasks. As loader 200 is a work vehicle, frame 210 also supports a traction system 240, which is also powered by power system 220 and can propel the power machine over a support surface. The lift arm assembly 230 in turn supports an implement interface 270, which includes an implement carrier 272 that can receive and secure various implements to the loader 200 for performing various work tasks and power couplers 274, to which an implement can be coupled for selectively providing power to an implement that might be connected to the loader. Power couplers 274 can provide sources of hydraulic or electric power or both. The loader 200 includes a cab 250 that defines an operator station 255 from which an operator can manipulate various control devices 260 to cause the power machine to perform various work functions. Cab 250 can be pivoted back about an axis that extends through mounts 254 to provide access to power system components as needed for maintenance and repair.

The operator station 255 includes an operator seat 258 and a plurality of operation input devices, including control levers 260 that an operator can manipulate to control various machine functions. Operator input devices can include buttons, switches, levers, sliders, pedals and the like that can be stand-alone devices such as hand operated levers or foot pedals or incorporated into hand grips or display panels, including programmable input devices. Actuation of operator input devices can generate signals in the form of electrical signals, hydraulic signals, or mechanical signals. Signals generated in response to operator input devices are provided to various components on the power machine for controlling various functions on the power machine. Among the functions that are controlled via operator input devices on loader 200 include control of the tractive elements 219, the lift arm assembly 230, the implement carrier 272, and providing signals to any implement that may be operably coupled to the implement.

Loaders can include human-machine interfaces including display devices that are provided in the cab 250 to give indications of information relatable to the operation of the power machines in a form that can be sensed by an operator, such as, for example audible or visual indications. Audible indications can be made in the form of buzzers, bells, and the like or via verbal communication. Visual indications can be made in the form of graphs, lights, icons, gauges, alphanumeric characters, and the like. Displays can provide dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided. Other power machines, such walk behind loaders may not have a cab nor an operator compartment, nor a seat. The operator position on such loaders is generally defined relative to a position where an operator is best suited to manipulate operator input devices.

Various power machines that can include or interact with the embodiments discussed below can have various different frame components that support various work elements. The elements of frame 210 discussed herein are provided for illustrative purposes and frame 210 is not the only type of frame that a power machine on which the embodiments can be practiced can employ. Frame 210 of loader 200 includes an undercarriage or lower portion 211 of the frame and a mainframe or upper portion 212 of the frame that is supported by the undercarriage. The mainframe 212 of loader 200, in some embodiments is attached to the undercarriage 211 such as with fasteners or by welding the undercarriage to the mainframe. Alternatively, the mainframe and undercarriage can be integrally formed. Mainframe 212 includes a pair of upright portions 214A and 214B located on either side and toward the rear of the mainframe that support lift arm assembly 230 and to which the lift arm assembly 230 is pivotally attached. The lift arm assembly 230 is illustratively pinned to each of the upright portions 214A and 214B. The combination of mounting features on the upright portions 214A and 214B and the lift arm assembly 230 and mounting hardware (including pins used to pin the lift arm assembly to the mainframe 212) are collectively referred to as joints 216A and 216B (one is located on each of the upright portions 214) for the purposes of this discussion. Joints 216A and 216B are aligned along an axis 218 so that the lift arm assembly is capable of pivoting, as discussed below, with respect to the frame 210 about axis 218. Other power machines may not include upright portions on either side of the frame or may not have a lift arm assembly that is mountable to upright portions on either side and toward the rear of the frame. For example, some power machines may have a single arm, mounted to a single side of the power machine or to a front or rear end of the power machine. Other machines can have a plurality of work elements, including a plurality of lift arms, each of which is mounted to the machine in its own configuration. Frame 210 also supports a pair of tractive elements in the form of wheels 219A-D on either side of the loader 200.

The lift arm assembly 230 shown in FIGS. 2-3 is one example of many different types of lift arm assemblies that can be attached to a power machine such as loader 200 or other power machines on which embodiments of the present discussion can be practiced. The lift arm assembly 230 is what is known as a vertical lift arm, meaning that the lift arm assembly 230 is moveable (i.e., the lift arm assembly can be raised and lowered) under control of the loader 200 with respect to the frame 210 along a lift path 237 that forms a generally vertical path. Other lift arm assemblies can have different geometries and can be coupled to the frame of a loader in various ways to provide lift paths that differ from the radial path of lift arm assembly 230. For example, some lift paths on other loaders provide a radial lift path. Other lift arm assemblies can have an extendable or telescoping portion. Other power machines can have a plurality of lift arm assemblies attached to their frames, with each lift arm assembly being independent of the other(s). Unless specifically stated otherwise, none of the inventive concepts set forth in this discussion are limited by the type or number of lift arm assemblies that are coupled to a particular power machine.

The lift arm assembly 230 has a pair of lift arms 234 that are disposed on opposing sides of the frame 210. A first end 232A of each of the lift arms 234 is pivotally coupled to the power machine at joints 216 and a second end 232B of each of the lift arms is positioned forward of the frame 210 when in a lowered position as shown in FIG. 2. Joints 216 are located toward a rear of the loader 200 so that the lift arms extend along the sides of the frame 210. The lift path 237 is defined by the path of travel of the second end 232B of the lift arms 234 as the lift arm assembly 230 is moved between a minimum and maximum height.

Each of the lift arms 234 has a first portion 234A of each lift arm 234 is pivotally coupled to the frame 210 at one of the joints 216 and the second portion 234B extends from its connection to the first portion 234A to the second end 232B of the lift arm assembly 230. The lift arms 234 are each coupled to a cross member 236 that is attached to the first portions 234A. Cross member 236 provides increased structural stability to the lift arm assembly 230. A pair of actuators 238, which on loader 200 are hydraulic cylinders configured to receive pressurized fluid from power system 220, are pivotally coupled to both the frame 210 and the lift arms 234 at pivotable joints 238A and 238B, respectively, on either side of the loader 200. The actuators 238 are sometimes referred to individually and collectively as lift cylinders. Actuation (i.e., extension and retraction) of the actuators 238 cause the lift arm assembly 230 to pivot about joints 216 and thereby be raised and lowered along a fixed path illustrated by arrow 237. Each of a pair of control links 217 are pivotally mounted to the frame 210 and one of the lift arms 232 on either side of the frame 210. The control links 217 help to define the fixed lift path of the lift arm assembly 230.

Some lift arms, most notably lift arms on excavators but also possible on loaders, may have portions that are controllable to pivot with respect to another segment instead of moving in concert (i.e., along a pre-determined path) as is the case in the lift arm assembly 230 shown in FIG. 2. Some power machines have lift arm assemblies with a single lift arm, such as is known in excavators or even some loaders and other power machines. Other power machines can have a plurality of lift arm assemblies, each being independent of the other(s).

An implement interface 270 is provided proximal to a second end 232B of the lift arm assembly 234. The implement interface 270 includes an implement carrier 272 that is capable of accepting and securing a variety of different implements to the lift arm 230. Such implements have a complementary machine interface that is configured to be engaged with the implement carrier 272. The implement carrier 272 is pivotally mounted at the second end 232B of the arm 234. Implement carrier actuators 235 are operably coupled the lift arm assembly 230 and the implement carrier 272 and are operable to rotate the implement carrier with respect to the lift arm assembly. Implement carrier actuators 235 are illustratively hydraulic cylinders and often known as tilt cylinders.

By having an implement carrier capable of being attached to a plurality of different implements, changing from one implement to another can be accomplished with relative ease. For example, machines with implement carriers can provide an actuator between the implement carrier and the lift arm assembly, so that removing or attaching an implement does not involve removing or attaching an actuator from the implement or removing or attaching the implement from the lift arm assembly. The implement carrier 272 provides a mounting structure for easily attaching an implement to the lift arm (or other portion of a power machine) that a lift arm assembly without an implement carrier does not have.

Some power machines can have implements or implement like devices attached to it such as by being pinned to a lift arm with a tilt actuator also coupled directly to the implement or implement type structure. A common example of such an implement that is rotatably pinned to a lift arm is a bucket, with one or more tilt cylinders being attached to a bracket that is fixed directly onto the bucket such as by welding or with fasteners. Such a power machine does not have an implement carrier, but rather has a direct connection between a lift arm and an implement.

The implement interface 270 also includes an implement power source 274 available for connection to an implement on the lift arm assembly 230. The implement power source 274 includes pressurized hydraulic fluid port to which an implement can be removably coupled. The pressurized hydraulic fluid port selectively provides pressurized hydraulic fluid for powering one or more functions or actuators on an implement. The implement power source can also include an electrical power source for powering electrical actuators or an electronic controller on an implement. The implement power source 274 also exemplarily includes electrical conduits that are in communication with a data bus on the excavator 200 to allow communication between a controller on an implement and electronic devices on the loader 200.

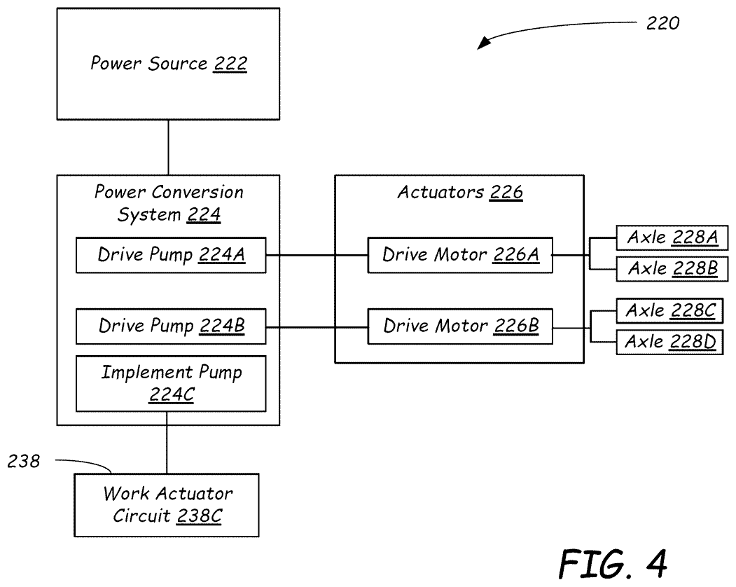

Frame 210 supports and generally encloses the power system 220 so that the various components of the power system 220 are not visible in FIGS. 2-3. FIG. 4 includes, among other things, a diagram of various components of the power system 220. Power system 220 includes one or more power sources 222 that are capable of generating or storing power for use on various machine functions. On loader 200, the power system 220 includes an internal combustion engine. Other power machines can include electric generators, rechargeable batteries, various other power sources or any combination of power sources that can provide power for given power machine components. The power system 220 also includes a power conversion system 224, which is operably coupled to the power source 222. Power conversion system 224 is, in turn, coupled to one or more actuators 226, which can perform a function on the power machine. Power conversion systems in various power machines can include various components, including mechanical transmissions, hydraulic systems, and the like. The power conversion system 224 of loader 200 includes a pair of hydrostatic drive pumps 224A and 224B, which are selectively controllable to provide a power signal to drive motors 226A and 226B. The drive motors 226A and 226B in turn are each operably coupled to axles, with drive motor 226A being coupled to axles 228A and 228B and drive motor 226B being coupled to axles 228C and 228D. The axles 228A-D are in turn coupled to tractive elements 219A-D, respectively. The drive pumps 224A and 224B can be mechanically, hydraulic, or electrically coupled to operator input devices to receive actuation signals for controlling the drive pumps.

The arrangement of drive pumps, motors, and axles in loader 200 is but one example of an arrangement of these components. As discussed above, loader 200 is a skid-steer loader and thus tractive elements on each side of the power machine are controlled together via the output of a single hydraulic pump, either through a single drive motor as in loader 200 or with individual drive motors. Various other configurations and combinations of hydraulic drive pumps and motors can be employed as may be advantageous.

The power conversion system 224 of loader 200 also includes a hydraulic implement pump 224C, which is also operably coupled to the power source 222. The hydraulic implement pump 224C is operably coupled to work actuator circuit 238C. Work actuator circuit 238C includes lift cylinders 238 and tilt cylinders 235 as well as control logic to control actuation thereof. The control logic selectively allows, in response to operator inputs, for actuation of the lift cylinders or tilt cylinders. In some machines, the work actuator circuit 238C also includes control logic to selectively provide a pressurized hydraulic fluid to an attached implement. The control logic of loader 200 includes an open center, 3 spool valve in a series arrangement. The spools are arranged to give priority to the lift cylinders, then the tilt cylinders, and then pressurized fluid to an attached implement.

The description of power machine 100 and loader 200 above is provided for illustrative purposes, to provide illustrative environments on which the embodiments discussed below can be practiced. While the embodiments discussed can be practiced on a power machine such as is generally described by the power machine 100 shown in the block diagram of FIG. 1 and more particularly on a loader such as track loader 200, unless otherwise noted or recited, the concepts discussed below are not intended to be limited in their application to the environments specifically described above.

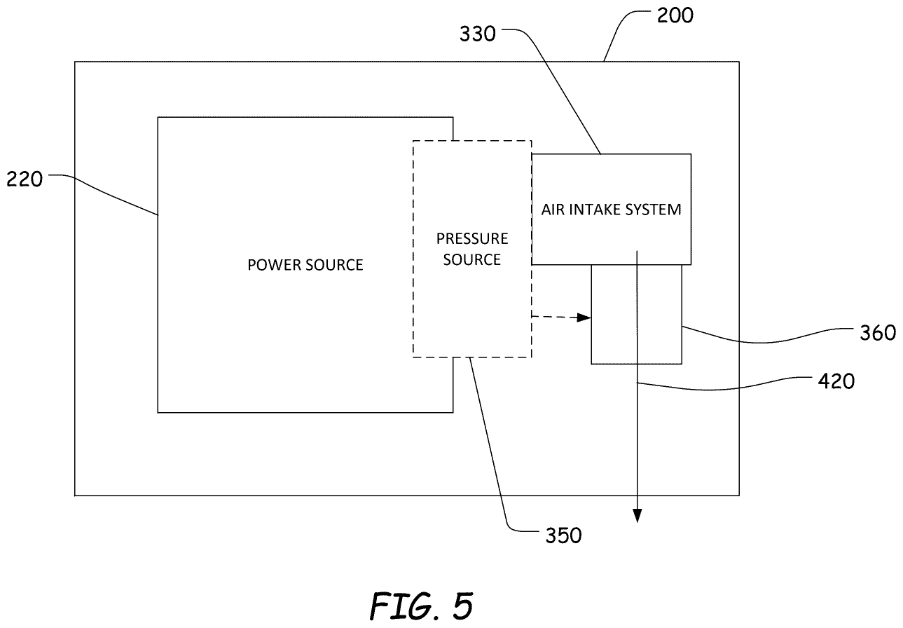

FIG. 5 illustrates an air intake system 330 for a power source 222 of the power system 220 (e.g., an internal combustion engine) for a particular configuration of the loader 200 (or other generally similar power machines). The air intake system 330 can be arranged on or near the power source 222 and can include an opening to receive air from an exterior of the loader 200. The intake air can be provided to the power source 222, such that the air can be mixed with fuel for combustion.

In some cases, a pressure source 350 can be provided to pressurize the flow of intake air into the power source 222 above atmospheric pressure. For example, the pressure source 350 can be a turbocharger, supercharger, or other boost air device that compresses intake air from the air intake system 330, such that the compressed air is forced into a power source. In some cases, the pressure source 350 can include a fan, a vacuum turbine, or various other known components to increase air pressure, as well as other equipment as needed (e.g., a charge air cooler), to provide pressurized (boosted) air to a power source. In some cases, other pressure sources can be provided (e.g., compressors, fans, or other boost systems not necessarily arranged to provide intake air to the engine).

As generally noted above, although the loader 200 can operate in a dusty environment, it may be advantageous to provide clean air to the power source 222. For example, air from the exterior of the loader 200 may include various contaminants, including debris, dust, bugs, or other undesirable solid particles, and performance can decrease when the contaminants are introduced into the power source 222.

Correspondingly, in some cases, the air intake system 330 can include a filter assembly (not separately shown in FIG. 5) that can filter contaminants from intake air, to provide filtered air to the power source 222. In some examples, the air intake system 330 can selectively filter out particular types or sizes of contaminants to control quality of intake air into the power source 222. In some cases, the air intake system 330 can operate continuously or selectively to provide filtered air to the power source.

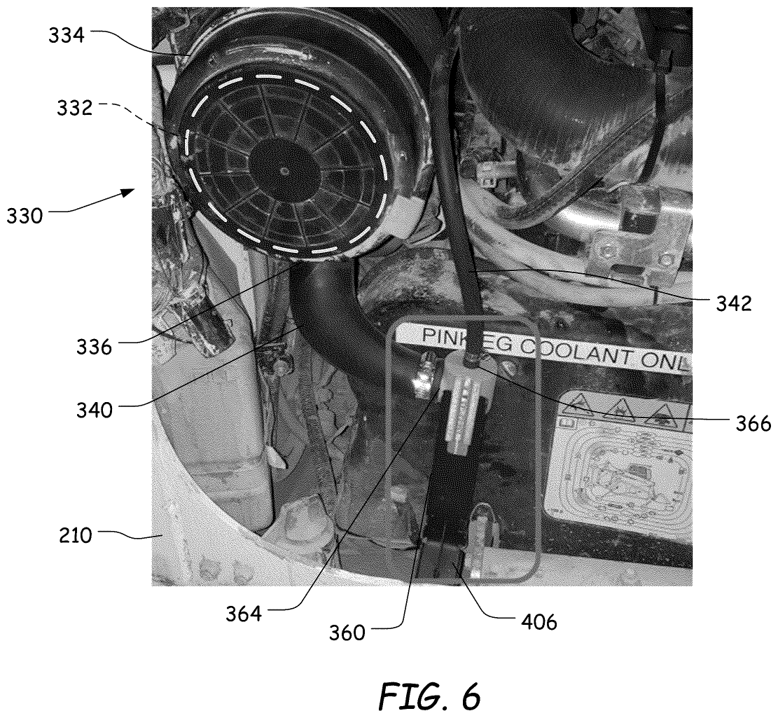

Continuing, an ejector 360 can also be provided (e.g., mounted to an exterior of the air intake system 330). Generally, the ejector 360 can provide (e.g., induce) a suction flow that draws contaminants (and air) out of the air intake system. For example, as also discussed below relative to FIG. 6, the ejector 360 can be in fluid communication with a filter housing of the air intake system 330 to cause a suction flow from the filter housing. This suction flow can cause a corresponding flow of contaminants out of the filter housing, through the ejector 360, and thus out of the air intake system 330 overall (e.g., along a direction 420 illustrated in FIG. 5).

Generally, pressurized air can be provided to the ejector 360 by the pressure source 350 to cause the removal of contaminants from the air intake system 330. In this regard, in some cases, a suction flow from the air intake system 330 can be caused by providing the ejector 360 with a flow of boost air. In other words, a portion of a pressurized air flow for operation of the power source 220 can be diverted to the ejector 360 to thereby induce a suction flow for removal of contaminants. Thus, with a relatively small diversion of air flow away from the air intake system 330 - and the power source 220, in particular - contaminants can be effectively removed from the air intake system 330, and overall power source performance can be correspondingly improved.

Boost air to remove contaminants can be diverted from a variety of boost systems of generally known types, including turbochargers, superchargers and other types of equipment for air compression. As noted above, for example, the pressure source 350 can provide a motive flow to the ejector 360 as a diverted portion of the boost air from the pressure source 350 for the power source 222.

In some examples, the ejector 360 can operate based on the Venturi principle, to induce a suction flow via expansion of a motive flow within a corresponding flow passage of the ejector 360. In other words, a higher pressure motive flow can expand within the ejector 360, and the resulting pressure differential within the ejector 360 can draw air from the air intake system 330 into the ejector 360 (e.g., via direct connections, tubes, fittings, etc. to provide fluid communication therebetween). In particular, airflow from the air intake system 330 into the ejector 360 can be drawn from a location at which contaminants filtered by a filter assembly of the air intake system 330 tend to reside or accumulate. The contaminants can thus be pulled from the air intake system 330, travel through the ejector 360 (i.e., as schematically indicated by the direction 420), and then be discharged (e.g., to an exterior of the loader 200).

In some cases, a relatively small amount of boost air can be diverted from the power source 222 for removal of contaminants (e.g., as a motive flow for a Venturi body). For example, a motive air flow can be diverted from a boost flow e.g., from an air cooler or other location of a turbocharger or other boost system, to reduce a boost flow by 1 psi or less as compared to the boost flow without the diversion. In some examples, a flow rate for the diverted boost air for contaminant removal can be 5% or less than a total flow rate for the boost air stream (or, e.g., 2% or less, 1% or less, 0.8% or less, etc.). Thus, the pressure source 350 can enhance an overall aspiration process to discharge contaminants from the air intake system 330, without significantly impeding airflow into the power source 222.

With reference to FIG. 6, in a particular example, the air intake system 330 can include an air filter housing 334 that includes an air filter 332 for filtering intake air of dust or contaminants (indicated schematically, because internal to the housing 234). As further detailed below, filtered contaminants can be removed from the air filter housing 334 by the ejector 360.

In the illustrated configuration, the air filter 332 is a cylindrical filter, although other configurations are possible. The air filtered through the air filter 332 can be provided to the power source 222 (e.g., as illustrated in FIG. 5), and filtered contaminants can be separated from the clean air to reside within the air filter housing 334. For example, the contaminants can be caused to swirl within the air filter housing 334 to be separated from the intake air and eventually settle or otherwise accumulate in a portion of the air filter housing 334.

Correspondingly, the ejector 360 can be in fluid communication with the air filter housing 334, to remove the accumulated contaminants. In some cases, the contaminants can accumulate in a bottom portion of the air filter housing 334. Correspondingly, in the illustrated example, the air filter housing 334 can include a housing outlet 336 on a bottom portion thereof. In particular, the housing outlet 336 can be connected to tubing 340 that provides fluid communication with the ejector 360, with the tubing 340 thus defining a suction flow path between the housing outlet 336 and a suction flow inlet 364 (e.g., a first inlet) of the ejector 360. Correspondingly, the ejector 360 may receive contaminants from the air filter housing 334 through the tubing 340. In other examples, however, other fluid connections are possible between an ejector and a filter housing (or other part of an air intake system).

Generally, the ejector 360 can be mounted at a variety of locations, including remotely from the air filter housing 334 as shown in FIG. 6 (e.g., mounted to the frame 210), directly on the air filter housing 334 (see, e.g., FIG. 5) or otherwise. In some cases, the suction flow inlet 364 may be positioned below the housing outlet 336, so that gravity can assist the air flow to pull contaminants down toward the ejector 360. Correspondingly, in some cases, the ejector 360 can generally be arranged for vertical motive flow and ejection, or can be otherwise oriented toward bottom of the loader 200 (e.g., toward ground). Thus arranged, the ejector 360 can guide contaminants to be discharged from the air filter housing 334 on the exterior of the loader 200.

Still referring to FIG. 6, the ejector 360 can include a motive flow inlet 366 (e.g., a second inlet) that is arranged to receive motive flow from the pressure source 350 (e.g., as illustrated in FIG. 5). For example, a motive flow hose 342 can define a motive flow path between the motive flow inlet 366 and the pressure source 350, or various other fluid connections can be provided.

As noted above, the ejector 360 can receive the motive flow as a diverted portion of boost air for the power source 222 to help to suction the contaminants from the air filter housing 334. For example, the ejector 360 can receive pressurized boost air through the motive flow hose 342 at the motive flow inlet 366. The corresponding motive flow within the ejector 360 can induce suction of contaminants from the air filter housing 334 into the ejector 360 (e.g., via an internal Venturi flow passage, not shown in FIG. 6). Correspondingly, the motive flow and the suction flow can be combined into a mixed flow that includes the contaminants and can be routed to exit the ejector 360 at an outlet thereof (e.g., to the surroundings, outside of the power machine 200).

In the illustrated configuration, the ejector 360 is supported by a bracket 406 to maintain the ejector 360 in a desired position. For example, the ejector 360 can include a clip that can slidably engage with the bracket 406 to hold the ejector 360 at a predetermined (or selected) height or lateral position on the loader 200. In the present configuration, the ejector 360 is at least partially suspended to the loader 200 by the bracket 406, although the bracket 406 may not be needed to hold the ejector 360 in place. For example, an arrangement of the tubing 340, the hose 242, or other fluid connection may provide sufficient rigidity to support a weight of the ejector 360 and hold the ejector 360 in a desired position. In some examples, the ejector 360 can be mounted directly (or otherwise) onto the air filter housing 334 or can be otherwise arranged remotely from the air filter housing 334.

Some examples can be constructed in a modular form, with different modular components being selectively combinable to provide particular flow characteristics, spatial footprints, mounting options, etc. For example, an ejector that operates under the Venturi principle may include one or more modules that define an inlet nozzle for motive flow, an inlet structure for a suction flow, a Venturi flow passage, or an outlet body for ejection of contaminants.

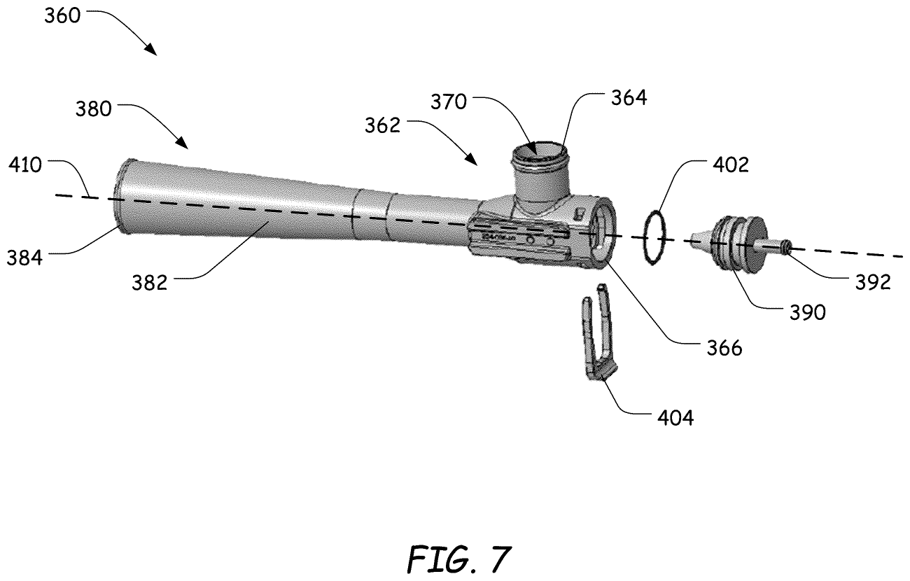

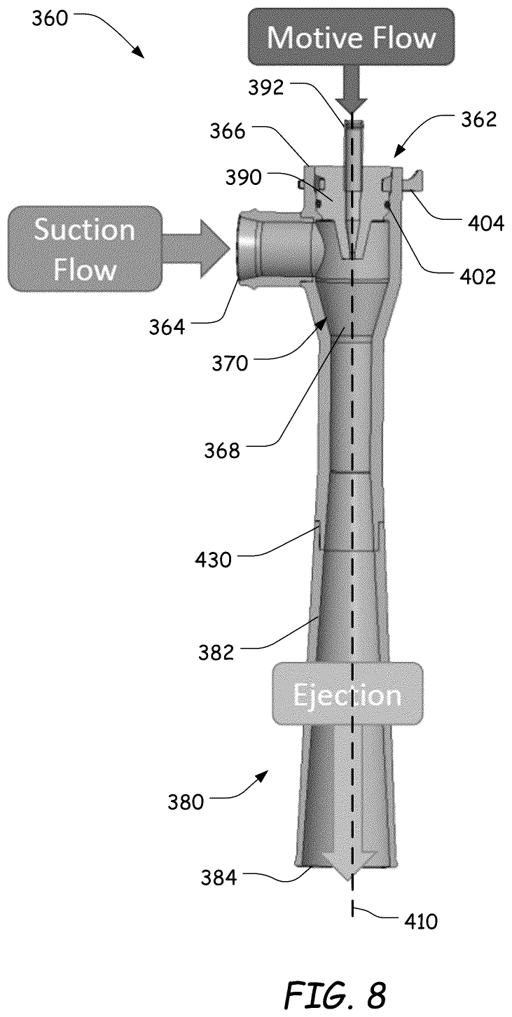

Referring to FIGS. 7 and 8, in particular, the ejector 360 can include a mixer body 362, an outlet body 380, and a nozzle body 390. The mixer body 362 can be a Venturi body in particular, formed to provide a particular internal Venturi passage (not shown in FIG. 7) alone or in combination with other components (e.g., the nozzle body 390, as shown). Further the mixer body 362 can include the suction flow inlet 364 and the motive flow inlet 366, arranged to extend in different directions (e.g., perpendicular directions), as well as a mixing chamber 368 that extends along an axis 410. In the illustrated embodiment, the mixing chamber 368 extends in a parallel direction with the motive flow inlet 366, although the mixing chamber 368 may extend in a parallel direction with the suction flow inlet 364 in some examples, or otherwise. The mixing chamber 368 can be an elongated tube that includes portions of converging or diverging cross-sectional areas (e.g., as also shown in FIG. 8), with a decreasing or increasing cross-sectional diameters, respectively, along the axis 410, including as can provide Venturi flow passages of various flow characteristics.

As shown in FIG. 8, in particular, the mixer body 362 can define an internal volume 370 that connects the suction flow inlet 364, the motive flow inlet 366, and the mixing chamber 368. Thus, as further described below, the suction flow and the motive flow may be mixed before being flowing out of the ejector 360.

Also as shown in FIG. 8, the motive flow inlet 366 can be arranged to removably receive the nozzle body 390. Thus, the nozzle body 390 and the mixer body 362 can collectively define a Venturi passage to induce suction flow at suction flow inlet 364 in response to motive flow through the nozzle body 390. In the illustrated example, the nozzle body 390 can also engage with the motive flow hose 342 (e.g., as shown in FIG. 6). Correspondingly, the nozzle body 390 can include a nozzle inlet 392 formed as a protruding tube with a relatively smaller diameter than the motive flow inlet 366 or the mixing chamber 368. The nozzle inlet 392 can extend along the axis 410 and be arranged co-axially with the mixer body 362 when the nozzle body 390 is inserted into the mixer body 362.

In the illustrated example, the nozzle body 390 can be a converging nozzle that opens to a portion of the mixer body 362 that includes a greater cross-sectional area than the nozzle body 390. Thus, motive flow that passes through the nozzle body 390 (e.g., along the axis 410) can both increase in velocity and decrease in pressure, and the decrease in pressure can induce suction flow into move the mixing chamber 368 via the suction flow inlet 364 (e.g., from the air filter housing as shown in FIG. 6). Correspondingly, the suction flow and the motive flow may be mixed within the mixing chamber 368, and the mixed flow may be discharged from the ejector 360. In other words, motive flow through the nozzle body 390 can generate a Venturi flow pattern within the mixer body 362 that permits effective removal of contaminants from the air filter housing 334. In some examples, the nozzle body 390 can be plastic or aluminum, although different types of materials are possible.

Generally, inclusion of a separate (e.g., removable) nozzle body can allow for modular customization of an ejector overall. In different examples, a modular (or other) nozzle body can be secured to an ejector assembly in different ways. As shown, for example, the nozzle body 390 can include annular grooves that engage with various features to operationally secure the nozzle body 390 to the mixer body 362. For example, as shown in FIG. 8, a sealing element 402 (e.g., an O-ring) can be provided in one (or more) of the grooves to enhance sealing between the nozzle body 390 and an inner wall of the mixer body 362. In some examples, legs of a clip 404 can extend through opposing sides of one (or more) of the grooves to secure the nozzle body 390 within the mixer body 362. In some cases, the clip 404 can permit easy removal of the nozzle body 390 from the mixer body 362 and a greater flexibility in removing or replacing the nozzle body 390. For example, nozzles of various parameters (e.g., size, length, shape, etc.) to correspondingly control parameters of motive flow (e.g., flowrate, pressure, etc.) can be selectively secured to the mixer body 362 using the clip 404. In some examples, however, different mechanisms can be provided to retain a nozzle body on a mixer body (e.g., dowels or cotter pins).

With continued reference to FIG. 7, the outlet body 380 can be positioned downstream (e.g., at a distal end) of the mixing chamber 368 and generally includes an outlet 384 that opens toward an exterior of the loader 200 or other surroundings. In the illustrated embodiment, the outlet body 380 can receive mixed airflow from the mixing chamber 368, expand the flow along a diffuser profile, and discharge the airflow at the outlet 384 in a direction along the axis 410.

In some examples, the outlet body 380 can be include a diffuser body 382 that is conically shaped or defines a conical flow passage. For example, cross-sections of the outlet body 382 can be circular and the corresponding flow passage can continuously taper outwardly toward the outlet 384 (e.g., diffuser outlet). That is, cross-sectional areas of the diffuser body 382 can increase in a direction toward the outlet 384 along the axis 410. Although the illustrated example includes an outlet body that is cone-shaped, an outlet (or diffuser) body or a flow passage therein can be defined by different shapes, including with lateral walls that curve outward or sections of lateral walls that taper at different angles or curve with different radii of curvature.

In some examples, the diffuser body 382 can taper out at a predetermined angle relative to the axis 410. In the illustrated example, the diffuser body 382 can taper outward at about 10 degrees relative to the axis 410. However, a diffuser body can taper outward at different angles, including less than 10 degrees, less than 15 degrees, less than 20 degrees, less than 25 degrees, less than 30 degrees, less than 45 degrees, less than 60 degrees, less than 90 degrees, and so forth. In some cases, an angle of taper of a diffuser body can be varied to control a range over which contaminants are dispersed at the diffuser outlet 384. For example, a wider angle of taper may permit contaminants to be dispersed over a larger area but may allow for relatively high throughput (e.g., due to relatively low accumulation of contaminants and correspondingly low back pressure). On the contrary, a narrower angle of taper may permit contaminants to be dispersed over a smaller area but may be more susceptible to reduction of throughput (e.g., due to accumulation of contaminants or other increase in back pressure).

Further, a length of the diffuser body 382 can be shortened or lengthened as needed for a particular application. For example, a particular length of the diffuser body 382 can help to direct airflow of the ejector 360 to an exterior of the loader 200. In some cases, varying a length of a diffuser body can amplify or reduce harshness of sound of airflow through an ejector.

As generally noted above, an outlet body (e.g., diffuser body) can be formed as a modular component, to allow selective customization of a particular ejector to a particular power machine, work site, operational application, etc. In this regard, for example, FIG. 8 illustrates an interface 430 between the mixer body 362 and the diffuser body 380. In the illustrated configuration, the diffuser body 380 can removably engage with the mixer body 362 and be detached from the mixer body 362, although the diffuser body 380 and the mixer body 362 can be uniformly formed in some examples. In particular, the diffuser body 380 can fit over a distal end of the mixing chamber 368 at the interface 430 with appropriate engagement so that the diffuser body 380 and the mixer body 362 remain coupled during operation of an aspiration process (e.g., snap or click-fit, interference fit, etc.). As discussed above, characteristics of the diffuser body 380 can be customized in a variety of ways, and the removable configuration of the diffuser body 380 can thus provide a great degree of modular customizability for the ejector 360.

A modular arrangement can also improve maintenance characteristics by allowing one or more parts of the ejector 360 to be easily disassembled for cleaning. For example, the suction flow inlet 364, the mixing chamber 368, or the diffuser body 380 may have contaminants build up over time along respective inner or outer walls. As illustrated, the diffuser body 380 can be decoupled from the mixer body 362 and cleaned or replaced with a different diffuser. Similarly, the mixer body 362 can be detached from the air intake system 330 or the pressure source 350 and cleaned or replaced with a different mixer. In some cases, the nozzle body 390 can include an oil build-up due to lubricant carried over from the pressure source 350. In these and other cases, the nozzle body 390 can be removed from the ejector 360 (e.g., by removing the clip 404 and pulling out the nozzle body 390 from the motive flow inlet 366) and cleaned or replaced with a different nozzle.

Although the present invention has been described by referring preferred embodiments, workers skilled in the art will recognize that changes may be made in form and detail without departing from the scope of the discussion.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C”indicate options of: A and B; B and C; A and C; and A, B, and C.

Also as used herein, unless otherwise limited or defined, “configured to” indicates that a component, system, or module is particularly adapted for the associated functionality. Thus, for example, an XX configured to YY is specifically adapted to YY, as opposed to merely being generally capable of doing so.

Unless otherwise specified or limited, the terms “about” and “approximately,” as used herein with respect to a reference value, refer to variations from the reference value of ±20% or less (e.g., ±15, ±10%, ±5%, etc.), inclusive of the endpoints of the range. Similarly, as used herein with respect to a reference value, the term “substantially equal” (and the like) refers to variations from the reference value of ±5% or less (e.g., ±2%, ±1%, ±0.5%) inclusive. Where specified in particular, “substantially” can indicate a variation in one numerical direction relative to a reference value. In particular, the term “substantially less” than a reference value (and the like) indicates a value that is reduced from the reference value by 30% or more (e.g., 35%, 40%, 50%, 65%, 80%), and the term “substantially more” than a reference value (and the like) indicates a value that is increased from the reference value by 30% or more (e.g., 35%, 40%, 50%, 65%, 80%).

Also as used herein, unless otherwise limited or defined, “substantially parallel” indicates a direction that is within ±12 degrees of a reference direction (e.g., within ±6 degrees or ±3 degrees), inclusive. Similarly, unless otherwise limited or defined, “substantially perpendicular” similarly indicates a direction that is within ±12 degrees of perpendicular a reference direction (e.g., within ±6 degrees or ±3 degrees), inclusive. Correspondingly, “substantially vertical” indicates a direction that is substantially parallel to the vertical direction, as defined relative to the reference system (e.g., a local direction of gravity, by default), with a similarly derived meaning for “substantially horizontal” (relative to the horizontal direction). Discussion of directions “transverse” to a reference direction indicate directions that are not substantially parallel to the reference direction. Correspondingly, some transverse directions may be perpendicular or substantially perpendicular to the relevant reference direction.

Also as used herein, unless otherwise limited or defined, “integral” and derivatives thereof (e.g., “integrally”) describe elements that are manufactured as a single piece without fasteners, adhesive, or the like to secure separate components together. For example, an element that is stamped, cast, or otherwise molded as a single-piece component from a single piece of sheet metal or other continuous single piece of material, without rivets, screws, other fasteners, or adhesive to hold separately formed pieces together, is an integral (and integrally formed) element. In contrast, an element formed from multiple pieces that are separately formed initially then later fastened together, is not an integral (or integrally formed) element.

Similarly, as used herein, unless otherwise defined or limited, the terms “interior” and “exterior” refers to a relative relationship (e.g., a lateral distance) between one or more structures (e.g., a sub-structure) and a centerline of a reference structure (e.g., a main structure) that extends in a front-to-back direction or between first and second ends of the reference structure. For example, an interior structure is disposed closer to a centerline of a reference structure than an exterior structure. In this regard, an outboard structure of a subassembly of a power machine may also be an exterior structure. In contrast, an exterior structure of a subassembly, relative to a centerline of the subassembly, may not necessarily be outboard of other components of the subassembly.

In some implementations, devices or systems disclosed herein can be utilized, manufactured, installed, etc. using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Some methods of the disclosed technology may be presented above or below with operations listed in a particular order. Unless otherwise required or specified, the operations of such methods can be implemented in different orders, in parallel, or as selected sub-sets of one or more individual operations (e.g., with a particular listed operation being implemented alone, rather than in combination with others).

What is claimed is:

1. A power machine, comprising:
a frame;
an engine supported by the frame; and
an air intake system that directs intake air to the engine, the air intake system including:
a filter assembly that includes: a filter housing and a filter element positioned in the filter housing to filter contaminants from the intake air;
a pressure source arranged to pressurize filtered air from the filter assembly and provide the pressurized filtered air to an intake of the engine; and
an ejector arranged to receive a portion of the pressurized filtered air and induce a suction flow at the filter housing to eject contaminants from the air intake system.

2. The power machine of claim 1, wherein the ejector includes a Venturi body that receives the portion of the pressurized filtered air to induce the suction flow.

3. The power machine of claim 1, wherein the ejector includes:
a nozzle that receives the portion of the pressurized filtered air from the pressure source;
a mixing chamber that receives the suction flow from the air intake system via a suction flow inlet, receives a motive flow of the pressurized filtered air from the nozzle, via the suction flow inlet, and combines the suction flow and the motive flow to provide a mixed flow; and
a diffuser that receives the mixed flow from the mixing chamber and discharges the mixed flow through a diffuser outlet to an exterior of the air intake system.

4. The power machine of claim 3, wherein the diffuser is removably engaged with a mixer body that includes the mixing chamber, the mixer body being selectively engageable with any of a plurality of diffusers with different outlet flow geometries.

5. The power machine of claim 4, wherein the nozzle is removably engaged with the mixer body.

6. The power machine of claim 3, wherein the mixing chamber includes a converging cross-sectional area downstream of the nozzle and the diffuser includes a diverging cross-sectional area downstream of the mixing chamber.

7. The power machine of claim 1, wherein the ejector is mounted to one or more of the frame or the filter housing.

8. The power machine of claim 1, wherein the pressure source is a turbocharger or a supercharger of the engine.

9. An air intake system for an engine of a power machine, the air intake system comprising:
a filter housing;
a filter element arranged in an airflow between an inlet and an outlet of the filter housing to filter contaminants from intake air for the engine; and
an ejector including a suction inlet port, a motive inlet port, a Venturi passage in fluid communication with the suction and motive inlet ports, and an outlet body in fluid communication with the Venturi passage, the motive inlet port being configured to receive a motive flow into the Venturi passage to induce a suction flow at the suction inlet port, the suction inlet port being in fluid communication with the filter housing to receive the filtered contaminants from the filter housing into the Venturi passage via the suction flow, and the outlet body being in fluid communication with the Venturi passage to eject the filtered contaminants from the air intake system.

10. The air intake system of claim 9, wherein one or more of the suction inlet port, the motive inlet port, or the Venturi passage is included in one or more modular bodies removably securable to the outlet body.

11. The air intake system of claim 9, wherein the outlet body is removably secured to a Venturi body that includes the Venturi passage.

12. The air intake system of claim 9, wherein the ejector is mounted remotely from the filter housing.

13. A method of operating an air intake system of a power machine, the method comprising:
operating the power machine to draw intake air into a filter housing of the air intake system to filter contaminants from the intake air;
with an ejector, inducing a vacuum flow to suction the contaminants from the filter housing; and
discharging the contaminants from the air intake system via the ejector.

14. The method of claim 13, further comprising:
providing pressurized air flow to the ejector to induce the vacuum flow.

15. The method of claim 14, wherein the pressurized air flow is provided by a boost air system for an engine of the power machine.

16. The method of claim 15, wherein providing the pressurized air flow to the ejector reduces a boost air flow from the boost air system to the engine by 1 psi or less.

17. The method of claim 13, further comprising:
configuring a flow characteristic of the ejector by selectively assembling onto the ejector one or more modular bodies of a plurality of modular bodies.

18. The method of claim 17, wherein configuring the flow characteristic includes selectively assembling onto the ejector one or more of:
a modular outlet body that defines an outlet flow geometry of the ejector; or
a modular nozzle body that defines an inlet flow geometry of the ejector.

19. The method of claim 18, wherein selectively assembling the modular outlet body onto the ejector includes selecting a diffuser body from a plurality of diffuser bodies that collectively include one or more of: a plurality of different outlet angles, or a plurality of different outlet lengths.

20. The method of claim 13, wherein the vacuum flow is 5% or less than a total intake air flow into the filter housing of the air intake system.
